(19) United States
(12) Patent Application Publication
(10) Pub. No.: US 2026/0154576 A1
(43) Pub. Date: Jun. 4, 2026

(54) INFORMATION PROCESSING APPARATUS, COMPUTER PROGRAM PRODUCT, AND INFORMATION PROCESSING METHOD

(71) Applicant: KABUSHIKI KAISHA TOSHIBA, Tokyo (JP)

(72) Inventors: Yingying LAO, Ota (JP); Yuichi KATO, Moriya (JP)

(73) Assignee: KABUSHIKI KAISHA TOSHIBA, Tokyo (JP)

(21) Appl. No.: 19/267,906

(22) Filed: Jul. 14, 2025

(30) Foreign Application Priority Data
Dec. 3, 2024 (JP) 2024-210067

(51) Int. Cl. G06N 5/04; G06F 40/289

(52) U.S. Cl. CPC G06N 5/04; G06F 40/289

(57) ABSTRACT

An information processing apparatus according to an embodiment executes refining processing for each of one or more task vectors. The refining processing is executed by correcting, to a default value, a value of a parameter whose degree of importance is smaller than degrees of importance of other parameters among parameters included in the task vector. The apparatus adjusts, by using training data for each of the one or more task vectors, a coefficient for correcting a corresponding one of the task vectors to an optimal task vector optimized for a target task. The apparatus generates, for each of the one or more task vectors, one or more optimal task vectors by multiplying the coefficient with a corresponding one of the task vectors. The apparatus generates a specialized model optimized for the target task by using a foundation model and the one or more optimal task vectors.

### CROSS-REFERENCE TO RELATED APPLICATIONS

This application is based upon and claims the benefit of priority from Japanese Patent Application No. 2024-210067, filed on Dec. 3, 2024; the entire contents of which are incorporated herein by reference.

### FIELD

Embodiments of the present invention relate to an information processing apparatus, a computer program product, and an information processing method.

### BACKGROUND

As a method of improving the task performance of a foundation model, there is a method of fine-tuning all parameters of the foundation model. However, for performing the fine-tuning on all parameters for each piece of new data, a very large computational cost is required.

As a technique of obtaining a model (specialized model) specialized for a task as a target (target task), a technique using a task vector has been known.

In such a technique, for example, a task vector for a target task is obtained by subtracting parameters (weights or the like) of the original model from those of a model fine-tuned for the target task using a pre-trained model (foundation model). Then, by the operations using the task vectors, it is possible to obtain a specialized model for a target task with a lower computational cost.

However, improvement in performance of the specialized model obtained by such a conventional technique is insufficient.

### BRIEF DESCRIPTION OF THE DRAWINGS

FIG. 1 is a block diagram of an information processing apparatus according to a first embodiment;

FIG. 2 is a diagram illustrating an example of a relationship among a foundation model, a task vector, and a parameter matrix;

FIG. 3 is a diagram illustrating an example of a division method;

FIG. 4 is a flowchart of model generation processing in the first embodiment;

FIG. 5 is a block diagram of an information processing apparatus according to a second embodiment;

FIG. 6 is a flowchart of model generation processing in the second embodiment;

FIG. 7 is a block diagram of an information processing apparatus according to a third embodiment;

FIG. 8 is a flowchart of model generation processing in the third embodiment;

FIG. 9 is a diagram illustrating an example of an operation screen;

FIG. 10 is a flowchart of model generation/confirmation processing; and

FIG. 11 is a hardware configuration diagram of the information processing apparatus according to the first to third embodiments.

### DETAILED DESCRIPTION

An information processing apparatus according to one embodiment includes one or more hardware processors. The hardware processors are configured to execute refining processing for each of one or more task vectors. The refining processing is executed by correcting, to a default value, a value of a parameter whose degree of importance is smaller than degrees of importance of other parameters among parameters included in the task vector. The hardware processors are configured to adjust, by using training data for each of the one or more task vectors, a coefficient for correcting a corresponding one of the task vectors to an optimal task vector optimized for a target task. The hardware processors are configured to generate, for each of the one or more task vectors, one or more optimal task vectors by multiplying the coefficient with a corresponding one of the task vectors. The hardware processors are configured to generate a specialized model optimized for the target task by using a foundation model and the one or more optimal task vectors.

Hereinafter, preferred embodiments of an information processing apparatus according to the present invention will be described in detail with reference to the accompanying drawings.

### First Embodiment

An information processing apparatus according to a first embodiment is configured to refine a task vector so as to retain a parameter with a high degree of importance useful for the target task. By using the refined task vector, it is possible to remove information that becomes noise with respect to inference of the target task and generate a model that can obtain higher inference performance.

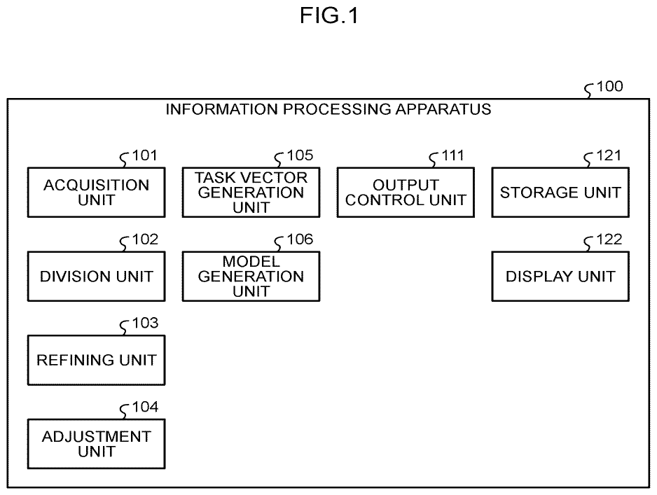

FIG. 1 is a block diagram illustrating an example of a configuration of an information processing apparatus 100 according to the first embodiment. As illustrated in FIG. 1, the information processing apparatus 100 includes a storage unit 121, a display unit 122, an acquisition unit 101, a division unit 102, a refining unit 103, an adjustment unit 104, a task vector generation unit 105, a model generation unit 106, and an output control unit 111.

The storage unit 121 stores various kinds of information used in the information processing apparatus. For example, the storage unit 121 stores training data for one or more target tasks. The target task is a task to be solved (downstream task) for a specific domain (also referred to as “field” or “area”) or for application scenario. In the field of natural language processing, there are downstream tasks such as information retrieval, text summarization, and text generation. In the field of an image analysis, there are downstream tasks such as object recognition (image classification), object detection (localization of objects), and semantic segmentation.

In a case where the target task is a maintenance operation, the training data for the target task is, for example, text data in which questions and answers related to the maintenance operation are paired.

The storage unit 121 may store training data for a domain to which the target task belongs. For example, business fields of industrial activities include domains such as healthcare, finance, and manufacturing. In a case where a domain is in an infrastructure field, the training data for the domain includes business documents in the infrastructure field, such as natural language documents like reports.

The storage unit 121 may store both the training data for the target task and the training data for the domain. The training data may be manually created or may be created by using an AI technology or the like. The training data may be data in any format. Hereinafter, examples of the format of the training data will be described.
Text data (including natural language data)
Image data (including moving image data and still image data)
Audio data
Music data
Time series data
Sensor data
Control signal data
Symbol data
Log data
Transaction data

The training data does not need to be data in one of the above-listed formats, and may include data in a plurality of formats. The training data may be data obtained by combining data in a plurality of formats.

Note that the storage unit 121 can be configured by any commonly used storage medium such as a flash memory, a memory card, a random access memory (RAM), a hard disk drive (HDD), and an optical disk.

The display unit 122 is a display device such as a liquid crystal display for displaying various kinds of information. For example, the display unit 122 displays various kinds of information under the control of the output control unit 111.

The acquisition unit 101 acquires various kinds of information used in the information processing apparatus 100. A method of acquiring information by the acquisition unit 101 may be any method, and for example, a method of receiving information from an external device via a network, a method of reading information from a storage medium, or the like can be applied.

For example, the acquisition unit 101 acquires one or more task vectors. Note that the specialized model can also be generated by combining a plurality of task vectors corresponding to a plurality of tasks with the foundation model. For example, by combining the task vector of a text generation task and the task vector of an image detection task, a specialized model specialized for these two tasks can be generated. In such a case, two or more task vectors may be obtained.

The task vector may be acquired in any manner, and is acquired by, for example, the following method.
Previously generated task vectors (published task vectors or the like) are acquired.
Task vectors are acquired by calculating a difference between a parameter of a foundation model trained in advance and a parameter of a model fine-tuned for the task as the foundation model. The foundation model and the fine-tuned model may be published models or models obtained by any other method.

Each model (foundation model or the like) is, for example, a neural network model. Hereinafter, an example in which the model is a neural network model including a plurality of layers (hierarchies) will be mainly described. Parameters of the model may be represented by any structure. Hereinafter, an example in which the parameter (parameter matrix) represented by a matrix format is used for each of layers will be mainly described. Since the task vector represents a difference of the parameters between two models, the task vector has the same structure as the model.

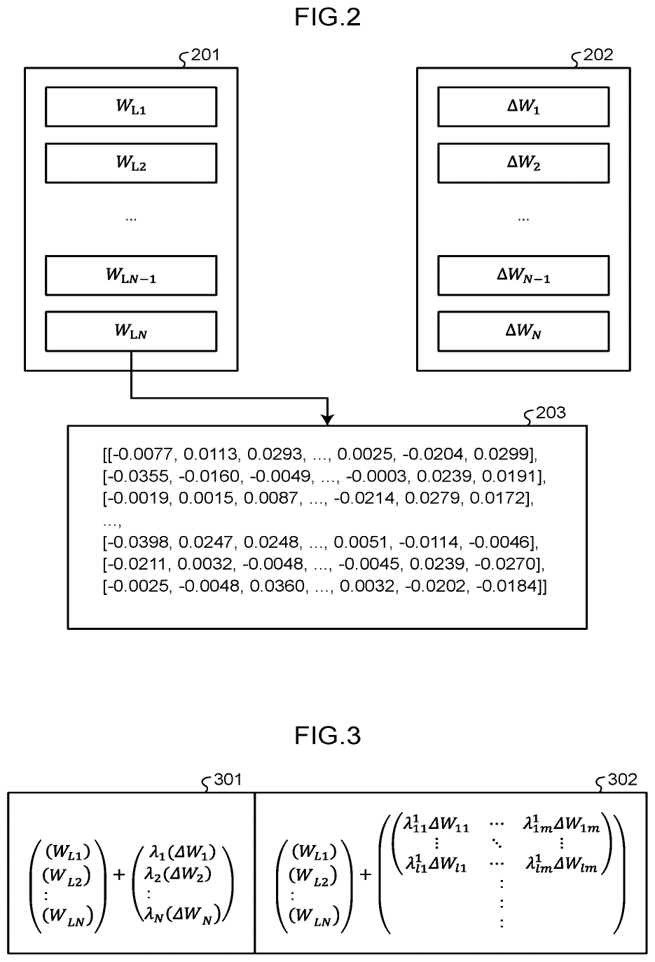

FIG. 2 is a diagram illustrating an example of a relationship among the foundation model, the task vector, and the parameter matrix. A foundation model 201 is a neural network model with N (N is an integer of 2 or more) layers. W_{Ln} (n is 1≤n≤N) represents a parameter matrix of the n-th layer of the foundation model 201. A task vector 202 is a task vector corresponding to the foundation model 201. ΔWₙ represents a parameter matrix of the n-th layer of the task vector 202. A parameter matrix 203 represents an example of a parameter matrix of one layer.

The description returns to FIG. 1. The division unit 102 divides each of one or more task vectors into plural blocks. The division method may be any method and can be applied the following.
(D1) Divide into blocks for each of layers.
(D2) Divide into blocks in accordance with characteristics of the layers. For example, task vectors may be divided into two blocks of lower-layer task vectors and upper-layer task vectors.
(D3) Divide into blocks along either one or both of a row and a column of the parameter matrix.

FIG. 3 is a diagram illustrating an example of a division method. A division example 301 corresponds to (D1) described above. A division example 302 corresponds to (D3) described above. In the present embodiment, a coefficient λ is adjusted for each divided block. In the division example 301, layer-specific coefficients λ₁ to Δ_{N} are adjusted. In the division example 302, row-specific and column-specific coefficients λ₁₁ to λₗₘ of the parameter matrix are adjusted. Then, for example, the specialized model is generated by adding the foundation model and the task vector multiplied by a coefficient. The division examples 301 and 302 can also be interpreted as representing the generated specialized model.

In a case where the task vector is more finely divided, the number of coefficients λ to be adjusted is increased. Therefore, a specialized model more suitable for the target task can be generated. Note that a single coefficient may be adjusted for the entire task vector without dividing the task vector. In this case, the division unit 102 may not be provided.

The description returns to FIG. 1. For each of one or more task vectors, the refining unit 103 executes refining processing by correcting, to a default value, a value of a parameter whose degree of importance (“usefulness” or “score”) is smaller than those of the other parameters among parameters included in the task vector. The default value is, for example, zero. In a case where the task vector is divided into blocks, the refining unit 103 may execute the refining processing for each of one or more task vectors and for each of blocks.

The degree of importance may be calculated by any of calculation methods (CM1) to (CM4) described below.
(CM1) The refining unit 103 calculates, as the degree of importance, an absolute value of a component of the foundation model corresponding to a component of the task vector or an absolute value of a component of the task vector. For example, when the component of the parameter of the foundation model is θᵢ and the component of the parameter of the task vector is φᵢ, the degree of importance s(φᵢ) is calculated by s(φᵢ)=|θᵢ| or s(φᵢ)=|φᵢ|.
(CM2) The refining unit 103 calculates, as the degree of importance, an absolute value of a value of the sum or difference between a component of the foundation model corresponding to a component of the task vector and a component of the task vector. For example, the degree of importance s(φᵢ) is calculated by s(φᵢ)=|θᵢ+φᵢ| or s(φᵢ)=|θᵢ−φᵢ|.
(CM3) The refining unit 103 calculates, as the degree of importance, a change in loss that is caused in inference using the specialized model. For example, when appropriate training data is set as D, a loss function is set as L, a parameter (parameter matrix) of the foundation model is set as θ, each component of the parameter is set as θᵢ, and a component of the parameter of the task vector is set as φᵢ, the degree of importance s(φᵢ) is calculated by s(φᵢ)=|(∂L(D;θ)/∂θᵢ)×φᵢ|.
(CM4) The refining unit 103 calculates, as the degree of importance, a comparison result between the sign of a component of the foundation model corresponding to a component of the task vector and the sign of a component of the task vector. For example, the degree of importance s(φᵢ) is calculated by s(φᵢ)=(θᵢ/|θᵢ|)×(φᵢ/|φᵢ|).

The parameter whose degree of importance is smaller than those of the other parameters may be determined as follows.
In the case of (CM1) to (CM3): a given percentage (γ %) of parameters in ascending order of the degree of importance, a given number of parameters in ascending order of the degree of importance, or parameters whose degree of importance is smaller than a threshold value
In the case of (CM4): parameters whose value of the degree of importance s(φᵢ) is “−1”

The adjustment unit 104 learns (adjusts) the coefficient for each block of the task vector by using training data so as to optimize for the target task. For example, the adjustment unit 104 adjusts, for each of one or more task vectors, a coefficient for correcting the task vector to an optimal task vector optimized for the target task by using the training data.

More specifically, the adjustment unit 104 trains a model obtained by adding the parameters of the refined task vector and the parameters of the foundation model, by using the training data. In the training, the adjustment unit 104 adjusts the coefficient for each block of the task vector while fixing the parameters of the foundation model and the parameters of the task vector.

The training method may be any method, and for example, a method of repeating adjustment of the value of the coefficient so as to reduce an error (loss) with respect to ground truth data included in the training data can be applied. Note that, since the adjusted coefficients are used for generating the specialized model, adjusting the coefficients can be interpreted as equivalent to training the specialized model.

The task vector generation unit 105 generates an optimal task vector by combining the refined task vector and the coefficient that is obtained as a result of the adjustment. For example, the task vector generation unit 105 generates one or more optimal task vectors by multiplying the task vector by the coefficient for each of one or more task vectors. Note that by setting the coefficient to 1, it is also possible to use only the refinement of the task vector.

The model generation unit 106 generates a specialized model optimized for the target task by using the foundation model and one or more optimal task vectors. For example, the model generation unit 106 generates a specialized model by combining the optimal task vector and the foundation model through operations such as addition or subtraction. The specialized model can also be interpreted as being generated by performing weighted addition of the foundation model and the task vector by using the adjusted coefficient. The foundation model may be the same model as the model used for training (for example, the model used for calculation of the task vector) or may be a different model.

As described above, the specialized model can also be generated by combining (multi-combining) plural task vectors with the foundation model. In such a case, each of the task vectors is combined with a corresponding block among the blocks.

The pattern of combining the optimal task vectors includes, for example, the following patterns.
(P1) A pattern in which one single task vector is combined with one foundation model.
(P2) A pattern in which two or more task vectors are combined with one foundation model.
(P3) A pattern in which one task vector is combined with each of foundation models.
(P4) A pattern in which two or more task vectors are combined with each of foundation models.

The output control unit 111 controls output of various kinds of information used in the information processing apparatus 100. For example, the output control unit 111 outputs the generated specialized model (parameters of the specialized model) to an external device or the like that uses the specialized model. In addition, the output control unit 111 displays, for example, a screen used for confirming the generated specialized model on the display unit 122. The method of outputting the information may be any method, and for example, a method of transmitting information to an external device via a network, a method of displaying information on the display unit 122, and the like can be applied.

At least some of the respective units (the acquisition unit 101, the division unit 102, the refining unit 103, the adjustment unit 104, the task vector generation unit 105, the model generation unit 106, and the output control unit 111) may be implemented by one or more processing units. Each unit described above is implemented by, for example, one or more hardware processors. For example, each unit described above may be implemented by causing a processor such as a central processing unit (CPU) and a graphics processing unit (GPU) to execute a program, namely, implemented by software. Each unit described above may be implemented by a processor such as a dedicated integrated circuit (IC), namely, implemented by hardware. Each unit described above may be implemented by using software and hardware together. In a case where a plurality of processors is used, each processor may implement one of the respective units, or may implement two or more of the respective units.

The information processing apparatus 100 may be physically configured by one apparatus or may be physically configured by two or more apparatuses. For example, the information processing apparatus 100 may be constructed on a cloud environment. In addition, each unit in the information processing apparatus 100 may be dispersedly provided in two or more apparatuses.

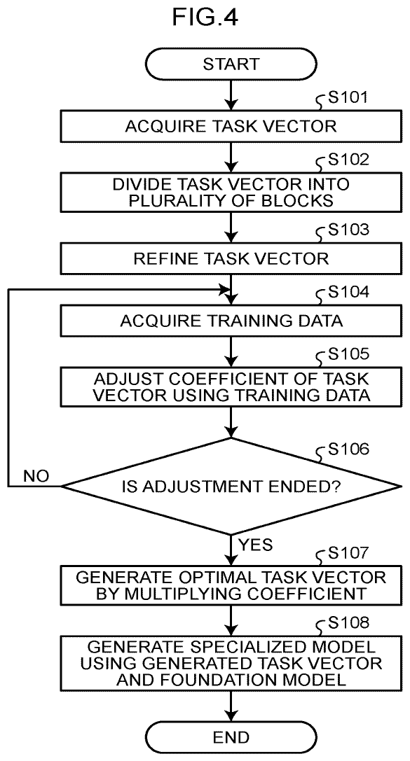

Next, model generation processing by the information processing apparatus 100 according to the first embodiment will be described. FIG. 4 is a flowchart illustrating an example of model generation processing in the first embodiment.

The acquisition unit 101 acquires a task vector (a parameter of the task vector) (step S101). For example, the acquisition unit 101 acquires a parameter matrix of the task vector by obtaining a difference between a parameter matrix of the foundation model trained in advance and a parameter matrix of the model obtained by fine-tuning the foundation model.

The division unit 102 divides the parameter matrix of the task vector into blocks (step S102).

The refining unit 103 refines the task vector (step S103). For example, the refining unit 103 determines a parameter with a high degree of importance based on the magnitude of the absolute value of each component (parameter) in the parameter matrix of the task vector. Then, the refining unit 103 corrects, to zero, a component of a parameter with a low degree of importance.

The acquisition unit 101 acquires the training data (step S104). For example, the acquisition unit 101 may acquire different training data for each iteration of processing of adjusting (training) the coefficient (steps S104 to S106).

The adjustment unit 104 adjusts the coefficient for each block of the task vector by using the training data so as to optimize for the target task (step S105). For example, the adjustment unit 104 trains a model (model under training) obtained by adding the parameters of the refined task vector and the parameters of the foundation model, by using the training data. In the training, for example, the coefficient for each block is adjusted to reduce the loss (error or the like with respect to the ground truth data) while the parameter of the task vector and the parameter of the foundation model are fixed.

The adjustment unit 104 determines whether or not to end the coefficient adjustment (step S106). For example, the adjustment unit 104 determines to end the adjustment in a case where the number of iterations of the processing reaches an upper limit value or in a case where the loss is equal to or less than a threshold value. In a case where the adjustment is not ended (step S106: No), the processing returns to step S104 and the process is repeated.

In a case where the adjustment is ended (step S106: Yes), the task vector generation unit 105 generates the optimal task vector by combining (for example, multiplying) the refined task vector and the coefficient for each block (step S107).

The model generation unit 106 generates a specialized model by combining the generated optimal task vector and the foundation model (step S108). In one example, the model generation unit 106 generates a specialized model by calculating the sum or the difference between the parameter matrix of the optimal task vector and the parameter matrix of the foundation model.

In this manner, the information processing apparatus according to the first embodiment refines the task vector so as to retain the parameter with a high degree of importance useful for the target task, and generates a specialized model by using the refined task vector. Therefore, it is possible to generate a model that can obtain higher inference performance specialized by the target task.

In addition, since it is possible to adjust the coefficient for each block of the task vector instead of adjusting all parameters of the model, computational cost can be reduced. Moreover, the model is generated by using the task vector. Therefore, it is possible to mitigate catastrophic forgetting as compared to techniques such as continual learning.

### Second Embodiment

An information processing apparatus according to a second embodiment adjusts the coefficient of the task vector by using an element (feature element) representing the feature of the training data among elements included in the training data.

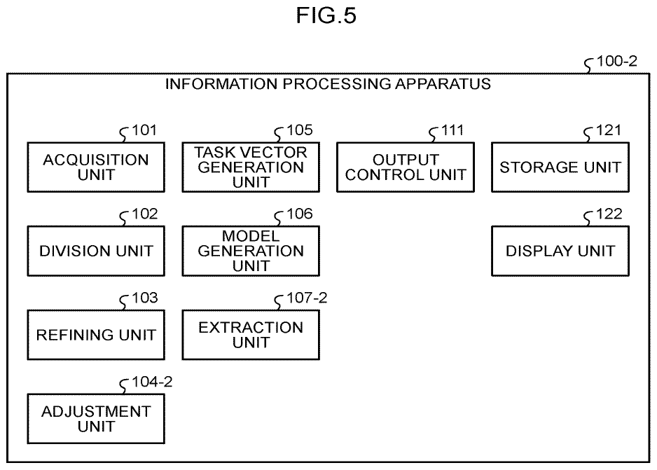

FIG. 5 is a block diagram illustrating an example of a configuration of an information processing apparatus 100-2 according to the second embodiment. As illustrated in FIG. 5, the information processing apparatus 100-2 includes the storage unit 121, the display unit 122, the acquisition unit 101, the division unit 102, the refining unit 103, an adjustment unit 104-2, the task vector generation unit 105, the model generation unit 106, an extraction unit 107-2, and the output control unit 111.

In the second embodiment, the extraction unit 107-2 is added, and the function of the adjustment unit 104-2 is different from that of the first embodiment. Other configurations and functions are similar to those in FIG. 1 that is a block diagram of the information processing apparatus 100 according to the first embodiment, and thus, are denoted by the same reference numerals, and description thereof is omitted here.

The extraction unit 107-2 extracts one or more feature elements each representing the feature of the training data among elements included in the training data. The feature element can be interpreted as an element representing the feature of the domain to which the training data belongs.

The element corresponds to the smallest unit that carries meaning in the training data. For example, in a case where the training data is text data, the element is a token including one or more morphemes. In a case where the training data is image data, the element is a pixel or a unit (such as a patch) including plural pixels. In a case where the training data is audio data, the element is a phoneme.

The method of extracting the feature elements may be any method, and extraction methods (EM1) to (EM3) described below can be used.
(EM1) A method of using a reference model. For example, the extraction unit 107-2 inputs the training data to the reference model, and acquires a loss of inference by the reference model for each element of the training data, as a reference loss (first loss). Next, the extraction unit 107-2 calculates a difference between the current loss (second loss), which is a loss of inference by the model under training, and the reference loss for each iteration of the processing of adjusting the coefficient (model under training) by using the training data. The extraction unit 107-2 extracts, as the feature elements, an element that corresponds to the difference being larger than the differences for the other elements. The element corresponding to the difference larger than differences for the other elements may be, for example, a given percentage (k %) of the top-ranked elements in descending order of the values of the difference, a given number of elements in descending order of the values of the difference, or elements having the values of the difference larger than the threshold value.
(EM2) A method using a system (a public tool or the like) having a function to extract feature elements. For example, it is possible to use an automatic term extraction tool (TermExtract or the like) that extracts technical terms from document data. The extracted technical terms correspond to the feature elements.
(EM3) A method of evaluating and extracting the degree of importance of each element. For example, indicators such as Term Frequency-Inverse Document Frequency (TFIDF), which are used in natural language processing to measure the degree of importance of words, can be used as the degree of importance. The extraction unit 107-2 extracts, as the feature elements, elements each of whose degree of importance is higher than those of other elements among elements of the training data, which is natural language data including multiple phrases as elements. The element whose degree of importance is larger than those of the other elements may be, for example, a given percentage (k %) of the top-ranked elements in descending order of the values of the degree of importance, a given number of elements in descending order of the values of the degree of importance, or elements having the values of the degree of importance larger than the threshold value.

The adjustment unit 104-2 adjusts the coefficient by using the feature elements. For example, the adjustment unit 104-2 adjusts the coefficient by preferentially by using the feature elements. For example, the adjustment unit 104-2 adjusts the coefficient for each block of the task vector by preferentially by using the loss (estimation loss) for estimating the feature elements, while the parameter of the foundation model and the parameter of the task vector are fixed.

As a method of prioritizing the estimation loss of the feature elements, there are the following methods.
Only the estimation loss of the feature elements is used.
The estimation loss of the feature element is scaled and used. For example, the estimation loss is scaled up or down by multiplying the estimation loss with a scaling factor, and then used.
An estimation loss LA of one or more feature elements and an estimation loss LB of an element, which is not a feature element, are weighted and used. For example, a higher weight is set to the estimation loss LA of the feature elements, and a lower weight is set to the estimation loss LB of the element, which is not the feature element.

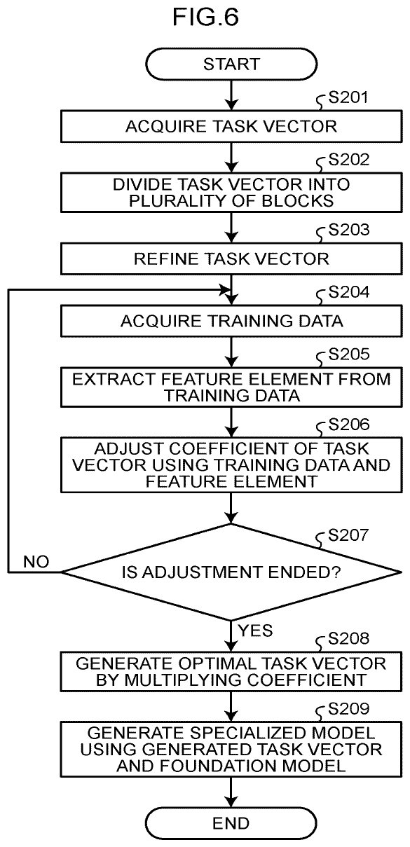

Next, model generation processing by the information processing apparatus 100-2 according to the second embodiment will be described by using FIG. 6. FIG. 6 is a flowchart illustrating an example of model generation processing in the second embodiment.

Steps S201 to S204 are similar to steps S101 to S104 in the information processing apparatus 100 of the first embodiment. Therefore, the description thereof will be omitted.

In the present embodiment, the extraction unit 107-2 extracts one or more feature elements from the training data in the iteration of the processing of adjusting the coefficient (step S205).

An example in which the specialized model to be generated is a language model will be described. The training data is text data, the reference model is a large language model (LLM) such as large language model Meta AI (Llama), and the loss function is a cross-entropy loss.

The extraction unit 107-2 inputs the training data (text data) into the LLM and acquires, as the reference loss, the loss of inference by the LLM for each token in the input text data. Next, the extraction unit 107-2 calculates, for each token, the difference between the current loss, which is the loss due to the model under training, and the reference loss. The extraction unit 107-2 sorts the differences and extracts, for example, the top k % of elements (tokens) in descending order of the differences as domain tokens of interest in the domain of the training data, namely, as the feature elements.

The adjustment unit 104-2 adjusts the coefficient of the task vector by using the training data and the extracted feature elements (step S206). For example, the adjustment unit 104-2 adjusts the coefficient for each block of the task vector by using the estimation loss of the extracted feature elements.

Since steps S207 to S209 are similar to steps S106 to S108 in the information processing apparatus 100 of the first embodiment, the description thereof will be omitted.

Note that, in the present embodiment, the refining processing of the task vector (step S203 in FIG. 6) may not be executed. Even with such a configuration, it is possible to generate a model that can obtain higher inference performance by the function of adjusting the coefficient by using one or more feature elements of the training data. Thus, in the present embodiment, the coefficient of the task vector can be adjusted by using one or more feature elements of the training data. In other words, in the present embodiment, domain-specific information can be efficiently incorporated by adjusting the coefficient of the task vector while focusing on the feature elements. Therefore, it is possible to generate a model that can obtain higher inference performance for the domain of the training data, for example.

### Third Embodiment

An information processing apparatus according to a third embodiment adjusts the coefficient of the task vector by using inference output information from an inference model that is different from the foundation model and the specialized model to be generated.

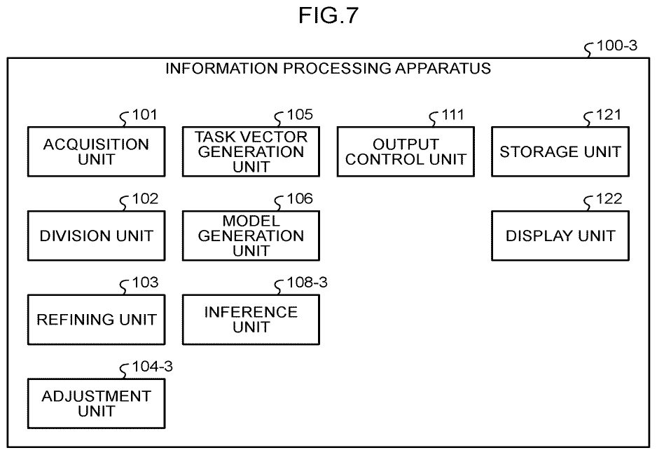

FIG. 7 is a block diagram illustrating an example of a configuration of an information processing apparatus 100-3 according to the third embodiment. As illustrated in FIG. 7, the information processing apparatus 100-3 includes the storage unit 121, the display unit 122, the acquisition unit 101, the division unit 102, the refining unit 103, an adjustment unit 104-3, the task vector generation unit 105, the model generation unit 106, an inference unit 108-3, and the output control unit 111.

In the third embodiment, the inference unit 108-3 is added, and the function of the adjustment unit 104-3 is different from that of the first embodiment. Other configurations and functions are similar to those in FIG. 1 that is a block diagram of the information processing apparatus 100 according to the first embodiment, and thus, are denoted by the same reference numerals, and description thereof is omitted here.

The inference unit 108-3 acquires inference output information for the training data by using an inference model that is configured to output inference output information in response to input of the training data. The inference output information is information output at the time of inference by the inference model. For example, the inference output information is an output of the final layer of the inference model (for example, Logits), a value obtained by applying a predefined function (for example, a Softmax function) to the output of the final layer, an output of the intermediate layer of the inference model, or the like.

The inference model may be any model, whereas it may be, for example, a representative foundation model of the domain related to the target task or a model specialized for that domain. In a case where the domain is language processing, the inference model is, for example, a closed LLM such as Generative Pre-trained Transformer 4 (GPT-4), or an open-source LLM such as Llama. In a case where the domain is image analysis, the inference model is, for example, an image analysis model such as a residual neural network (ResNet) or a Vision Transformer.

The adjustment unit 104-3 adjusts the coefficient by using the training data and the inference output information. For example, the adjustment unit 104-3 adjusts the coefficients through knowledge distillation (knowledge distillation learning) using a loss for bringing the inference output information, which is the output of the inference model, closer to the output of the specialized model.

More specifically, the adjustment unit 104-3 adjusts the coefficients for each block of the task vector by using a loss between the output distributions of the inference model and the model under training such that the distribution of the output (output distribution) of the model under training (student model) matches the desired output distribution, which is the inference output information from the inference model (teacher model). The loss between the output distributions may be calculated by using, for example, Kullback Leibler divergence.

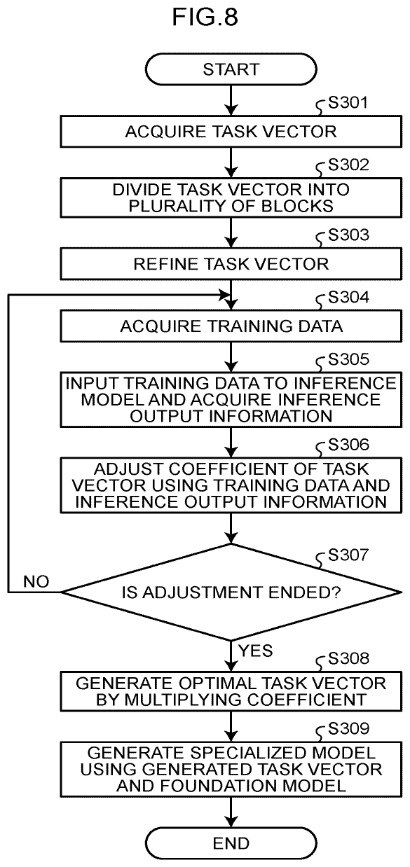

Next, model generation processing by the information processing apparatus 100-3 according to the third embodiment will be described by using FIG. 8. FIG. 8 is a flowchart illustrating an example of model generation processing in the third embodiment.

Since steps S301 to S304 are similar to steps S101 to S104 in the information processing apparatus 100 of the first embodiment, the description thereof will be omitted.

In the present embodiment, in the iteration of the processing of adjusting the coefficient, the inference unit 108-3 inputs the training data to the inference model, and acquires the inference output information output by the inference model (step S305). For example, the inference unit 108-3 inputs text data being the training data to the LLM (inference model), and acquires the logit output by the LLM, as the inference output information.

The adjustment unit 104-3 adjusts the coefficient of the task vector by using the training data and the inference output information (step S306). For example, the adjustment unit 104-3 performs knowledge distillation by using the inference output information and adjusts the coefficient for each block of the refined task vector.

Since steps S307 to S309 are similar to steps S106 to S108 in the information processing apparatus 100 of the first embodiment, the description thereof will be omitted.

Note that, in the present embodiment, the refining processing of the task vector (step S303 in FIG. 8) may not be executed. Even with such a configuration, it is possible to generate a model that can obtain higher inference performance by the function of executing knowledge distillation using the inference output information of the inference model. Therefore, in the present embodiment, by adjusting the coefficient of the task vector through knowledge distillation while incorporating the knowledge of the inference model, the performance of the specialized model to be generated can be improved.

### Example of User Interface

Next, an example of a user interface applicable to each embodiment (first to third embodiments) described above will be described.

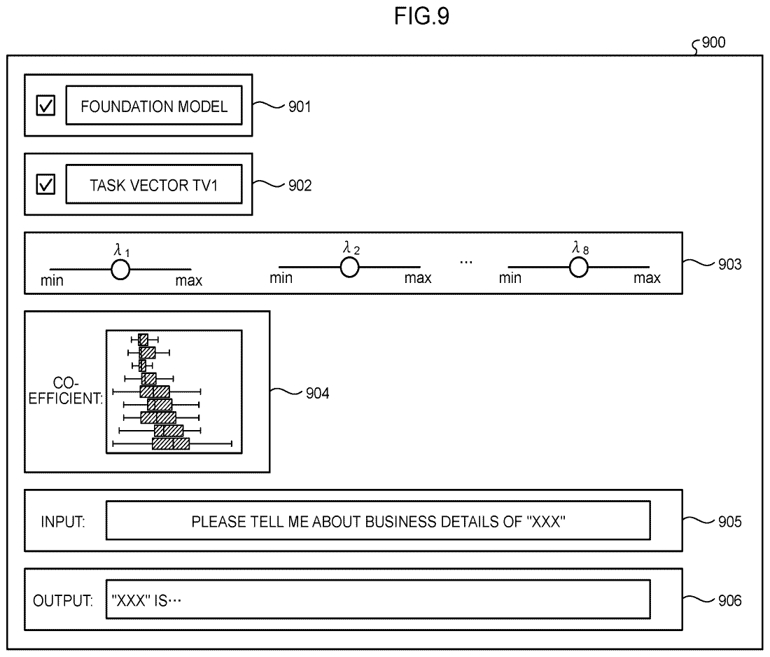

FIG. 9 is a diagram illustrating an example of an operation screen 900 that can be used for generation of the specialized model, confirmation of the generated specialized model, and the like. For example, the output control unit 111 displays the operation screen 900 as illustrated in FIG. 9 on the display unit 122.

The operation screen 900 includes a model selection field 901, a vector selection field 902, a coefficient change field 903, a coefficient display field 904, an input field 905, and an output field 906.

The model selection field 901 is a field for selecting a foundation model. The vector selection field 902 is a field for selecting a task vector to be combined with the foundation model. For example, the model selection field 901 and the vector selection field 902 may be, for example, in a format that allows a desired option to be selected from among plural options by checkboxes, or in a format that allows a desired option to be selected from among plural options by a dropdown menu.

The coefficient change field 903 is a field for further changing the coefficient adjusted by the method of each embodiment. In the operation screen 900, an example of the coefficient change field 903 for changing eight coefficients λ₁ to λ₈ corresponding to eight layers of the foundation model is illustrated. The coefficient change field 903 is in a format for changing the coefficient by using a slide bar, but may be a field in which the coefficient is changed in any other format.

min and max are, for example, a minimum value and a maximum value of predetermined coefficients. For example, the output control unit 111 sets the value of the coefficient obtained by the method of each embodiment as an initial value of the coefficient to be displayed on the slide bar of the coefficient change field 903.

The coefficient display field 904 is a field for displaying the state of the coefficient. For example, a user can confirm whether or not the change state of the task vector is optimized by the coefficient displayed in the coefficient display field 904.

In a case where the coefficient is changed by the coefficient change field 903, the specialized model is changed by the changed coefficient. For example, the task vector generation unit 105 generates an optimal task vector by combining the changed coefficient and the refined task vector. The model generation unit 106 generates a specialized model by using the foundation model and the optimal task vector.

The input field 905 is a field used for designating, by a user, an input to the specialized model after the change. In a case where the input of the specialized model is designated in the input field 905, the output control unit 111 inputs the designated input to the specialized model, and acquires the output of the specialized model.

The output field 906 is a field for displaying the output of the specialized model.

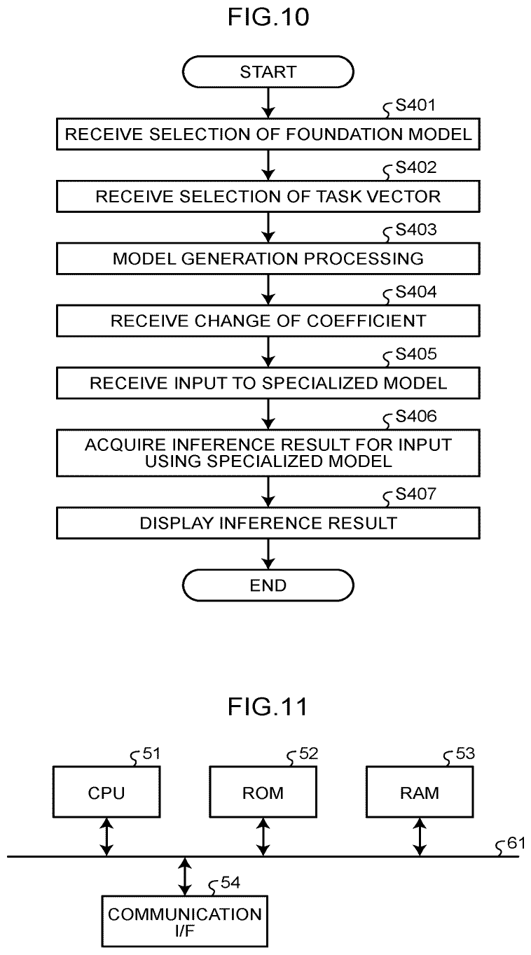

Next, an example of the model generation/confirmation processing using the operation screen 900 as illustrated in FIG. 9 will be described. FIG. 10 is a flowchart illustrating an example of the model generation/confirmation processing.

The output control unit 111 displays the operation screen 900 as illustrated in FIG. 9 on the display unit 122. The user selects the foundation model on the operation screen 900. The output control unit 111 receives selection of the foundation model (step S401). In addition, the user selects the task vector on the operation screen 900. The output control unit 111 receives selection of the task vector (step S402).

Thereafter, model generation processing by the method of each embodiment is executed (step S403). The output control unit 111 may display the value of the coefficient obtained by the model generation processing, in the coefficient change field 903 (initial value) and the coefficient display field 904.

In a case where the coefficient is changed in the coefficient change field 903 of the operation screen 900, the output control unit 111 receives the change of the coefficient (step S404). In a case where the coefficient is changed by the coefficient change field 903, the specialized model is changed by the changed coefficient.

In a case where the input of the specialized model is designated in the input field 905, the output control unit 111 receives the input to the specialized model (step S405). The output control unit 111 inputs the designated input to the specialized model, and acquires an inference result that is the output of the specialized model (step S406). The output control unit 111 displays the inference result in the output field 906 (step S407), and ends the model generation/confirmation processing.

As described above, according to the first to third embodiments, it is possible to generate a model that can obtain higher inference performance for a desired task.

Next, a hardware configuration of the information processing apparatus according to the first to third embodiments will be described by using FIG. 11. FIG. 11 is an explanatory diagram illustrating a hardware configuration example of the information processing apparatus according to the first to third embodiments.

The information processing apparatus according to the first to third embodiments includes a control device such as a central processing unit (CPU) 51, a storage device such as a read only memory (ROM) 52 or a random access memory (RAM) 53, a communication I/F 54 that is connected to a network to perform communication, and a bus 61 that connects respective units.

A computer program executed by the information processing apparatus according to the first to third embodiments is provided by being installed in advance in the ROM 52 or the like.

The computer program executed by the information processing apparatus according to the first to third embodiments may be provided as a computer program product by being recorded as a file in an installable format or an executable format in a computer-readable recording medium such as a compact disk read only memory (CD-ROM), a flexible disk (FD), a compact disk recordable (CD-R), and a digital versatile disk (DVD).

Moreover, the computer program executed by the information processing apparatus according to the first to third embodiments may be provided by being stored in a computer connected to a network such as the Internet and downloaded via the network. The computer program executed by the information processing apparatus according to the first to third embodiments may be provided or distributed via a network such as the Internet.

The computer program executed by the information processing apparatus according to the first to third embodiments can cause a computer to function as each unit of the information processing apparatus described above. In this computer, the CPU 51 can read and execute a program from a computer-readable storage medium onto a main storage device.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus comprising
one or more hardware processors configured to:
execute refining processing for each of one or more task vectors, the refining processing being executed by correcting, to a default value, a value of a parameter whose degree of importance is smaller than degrees of importance of other parameters among parameters included in the task vector;
adjust, by using training data for each of the one or more task vectors, a coefficient for correcting a corresponding one of the task vectors to an optimal task vector optimized for a target task;
generate, for each of the one or more task vectors, one or more optimal task vectors by multiplying the coefficient with a corresponding one of the task vectors; and
generate a specialized model optimized for the target task by using a foundation model and the one or more optimal task vectors.

2. The information processing apparatus according to claim 1, wherein the hardware processors are further configured to
divide each of the one or more task vectors into blocks, and
perform the adjustment of the coefficient for each of the blocks.

3. The information processing apparatus according to claim 1, wherein the hardware processors are further configured to:
extract one or more feature elements each representing a feature of the training data from among elements included in the training data; and
perform the adjustment of the coefficient by using the training data and the one or more feature elements.

4. The information processing apparatus according to claim 3, wherein the hardware processors are further configured to
perform the adjustment of the coefficient by preferentially using the one or more feature elements.

5. The information processing apparatus according to claim 3, wherein the hardware processors are further configured to
extract, as the one or more feature elements from among the elements included in the training data, one or more elements corresponding to a difference between a first loss and a second loss being larger than differences for the other elements included in the training data, the first loss being caused in inference by a reference model using the training data, the second loss being caused in inference by the specialized model.

6. The information processing apparatus according to claim 3, wherein
the training data is natural language data including phrases as elements, and
the hardware processors are further configured to extract, as the one or more feature elements from among the phrases included in the training data, one or more phrases whose degree of importance larger than degrees of importance of the other phrases.

7. The information processing apparatus according to claim 1, wherein the hardware processors are further configured to:
acquire inference output information for the training data by using an inference model serving to output inference output information in response to input of the training data; and
perform the adjustment of the coefficient by using the training data and the inference output information.

8. The information processing apparatus according to claim 7, wherein the hardware processors are further configured to
perform the adjustment of the coefficient by knowledge distillation using a loss for bringing the inference output information output by the inference model closer to an output of the specialized model.

9. The information processing apparatus according to claim 1, wherein the default value is zero.

10. The information processing apparatus according to claim 1, wherein the hardware processors are further configured to
calculate, as the degree of importance, an absolute value of a component of the foundation model corresponding to a component of the task vector, or an absolute value of a component of the task vector.

11. The information processing apparatus according to claim 1, wherein the hardware processors are further configured to
calculate, as the degree of importance, an absolute value of a value of a sum or a difference between a component of the foundation model corresponding to a component of the task vector and a component of the task vector.

12. The information processing apparatus according to claim 1, wherein the hardware processors are further configured to calculate, as the degree of importance,
a change in loss caused in inference by the specialized model.

13. The information processing apparatus according to claim 1, wherein the hardware processors are further configured to
calculate, as the degree of importance, a comparison result between a sign of a component of the foundation model corresponding to a component of the task vector and a sign of a component of the task vector.

14. The information processing apparatus according to claim 1, wherein the hardware processors are further configured to:
execute the refining processing for one of the task vectors;
adjust the coefficient for the one of the task vectors;
generate one of the optimal task vectors by multiplying the coefficient with the one of the task vector; and
generate the specialized model by using the foundation model and the one of the optimal task vectors.

15. The information processing apparatus according to claim 1, wherein the hardware processors are further configured to:
execute the refining processing for each of the task vectors;
adjust the coefficient for each of the task vectors;
generate the optimal task vectors by multiplying the coefficient with the task vector for each of the task vectors; and
generate the specialized model by using the foundation model and the optimal task vectors.

16. An information processing apparatus comprising
one or more hardware processors configured to:
extract one or more feature elements each representing a feature of training data from among elements included in the training data;
execute refining processing for each of one or more task vectors, the refining processing being executed by correcting, to a default value, a value of a parameter whose degree of importance is smaller than degrees of importance of other parameters among parameters included in the task vector;
adjust, by using the training data and the one or more feature elements for each of the one or more task vectors, a coefficient for correcting a corresponding one of the task vectors to an optimal task vector optimized for a target task;
generate, for each of the one or more task vectors, one or more optimal task vectors by multiplying the coefficient with a corresponding one of the task vectors; and
generate a specialized model optimized for the target task by using a foundation model and the one or more optimal task vectors.

17. An information processing apparatus comprising
one or more hardware processors configured to:
acquire inference output information for a training data by using an inference model serving to output the inference output information in response to input of the training data;
execute refining processing for each of one or more task vectors, the refining processing being executed by correcting, to a default value, a value of a parameter whose degree of importance is smaller than degrees of importance of other parameters among parameters included in the task vector;
adjust, by using the training data and the inference output information for each of the one or more task vectors, a coefficient for correcting a corresponding one of the task vectors to an optimal task vector optimized for a target task;
generate, for each of the one or more task vectors, one or more optimal task vectors by multiplying the coefficient with a corresponding one of the task vectors; and
generate a specialized model optimized for the target task by using a foundation model and the one or more optimal task vectors.

18. A computer program product comprising a non-transitory computer readable recording medium on which a program executable by a computer is recorded, the program instructing the computer to:
execute refining processing for each of one or more task vectors, the refining processing being executed by correcting, to a default value, a value of a parameter whose degree of importance is smaller than degrees of importance of other parameters among parameters included in the task vector;
adjust, by using training data for each of the one or more task vectors, a coefficient for correcting a corresponding one of the task vectors to an optimal task vector optimized for a target task;
generate, for each of the one or more task vectors, one or more optimal task vectors by multiplying the coefficient with a corresponding one of the task vectors; and
generate a specialized model optimized for the target task by using a foundation model and the one or more optimal task vectors.

19. An information processing method implemented by a computer, the method comprising:
executing refining processing for each of one or more task vectors, the refining processing being executed by correcting, to a default value, a value of a parameter whose degree of importance is smaller than degrees of importance of other parameters among parameters included in the task vector;
adjusting, by using training data for each of the one or more task vectors, a coefficient for correcting a corresponding one of the task vectors to an optimal task vector optimized for a target task;
generating, for each of the one or more task vectors, one or more optimal task vectors by multiplying the coefficient with a corresponding one of the task vectors; and
generating a specialized model optimized for the target task by using a foundation model and the one or more optimal task vectors.
